(19) United States
(12) Patent Application Publication
(10) Pub. No.: US 2009/0112455 A1
(43) Pub. Date: Apr. 30, 2009

(54) METHOD AND SYSTEM FOR RENDERING SIMPLIFIED POINT FINDING MAPS

(75) Inventors: Philip L. Bohannon, Cupertino, CA (US); Ronald D. Gutman, San Jose, CA (US); John-Reid Conlin, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/923,378

(22) Filed: Oct. 24, 2007

(51) Int. Cl. G01C 21/34

(52) U.S. Cl. 701/200

(57) ABSTRACT

A method and system for rendering simplified point finding maps is provided. The method may include defining a boundary area and a target point within a target area, on a map that comprises multiple roads segments. A plurality of routes that follow the road segments and go from the boundary area to the target point may be selected. Road segments that are not necessary to the routes may be removed from the map.

### BACKGROUND

The growth of the internet has fueled a boom in web based applications. For example, numerous search engines are now available that allow a website user to find a wide variety information with the click of a button. In addition to search engines, a variety of map applications are available. Some of these map applications allow a user to zoom in and out at almost any point on the globe. In some cases, satellite imagery may be overlaid on the map so that the user can see actual roads, buildings and terrain.

Some map applications allow a user to plan a route and to create a printout of that route. For example, a user may specify a source and destination address in the map application and the application may then create a route connecting the two addresses. Often times this may be accomplished by simply highlighting the road segments that make up the route. Once the route has been determined, the user may print up the map and use it to find his way to the destination address. For very short distances this method may work well. For example, a map depicting a route from ones home to a nearby business may be easy to follow because the source address, destination address, and side streets may be easily identified on a single sheet of paper.

Routes that cover larger distances, however, may become more difficult to follow utilizing a single sheet of paper. For example, it may be difficult to identify local roads near a destination address where a route spans hundreds of miles. In this case, the user may have break up the map into multiple sheets of paper so that there is enough detail near the destination address to aid in navigation. In addition to taking multiple sheets, the printout may show roads that have no bearing on the route between the source and destination addresses. This may have the effect of cluttering the map and making it difficult to follow.

Another problem with current map applications is that they do not facilitate showing multiple routes to a particular destination, which may be useful for the owner of a business. For example, a businessman may want to deliver a map to potential customers detailing various routes which customers may travel to reach his store. However, potential customers may be scattered throughout a metropolitan area. Creating multiple detailed maps showing routes to the business from various areas may prove cumbersome. Moreover, the businessman may not know exactly which route the customers may prefer. A similar problem exists for a user who wants to invite friends from throughout a metropolitan area to his house for a party.

### BRIEF SUMMARY

A system and/or method is provided for rendering simplified point finding maps, substantially as shown in and/or described in connection with at least one of the figures, as set forth more completely in the claims. The system and/or method may include defining a boundary area and a target point within a target area, on a map that comprises multiple roads segments. A plurality of routes that go from the boundary area to the target point may be selected. Road segments that are not necessary to the routes may be removed from the map while road segments that intersect the routes may be included. The area of the map corresponding to the target area may be expanded to show more information.

The routes may be computed by treating the roads segments of the map as a weighted graph and the target point as a destination vertex and computing the plurality of routes using an algorithm that searches backwards from the vertex. The road segments may be rated by the number of routes on which they appear. Alternatively, the routes may be determined by selecting random locations outside the target area and generating multiple routes from the random locations to the target point.

These and other advantages, aspects and novel features will be more fully understood from the following description and drawings.

### BRIEF DESCRIPTION

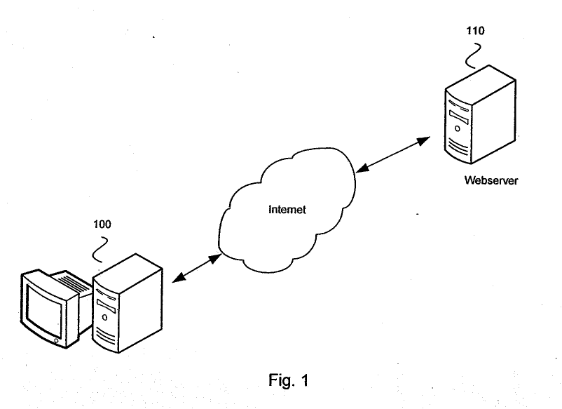

FIG. 1 is a diagram of a user terminal connected to a web server via the internet

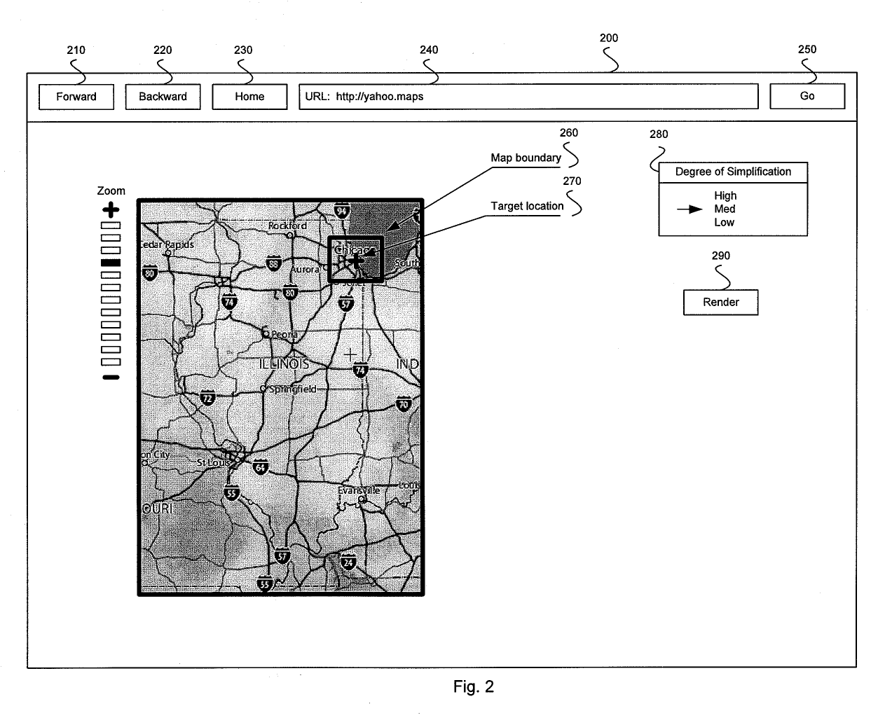

FIG. 2 is an exemplary webpage depicting an area on a map to be rendered as a simplified point finding map

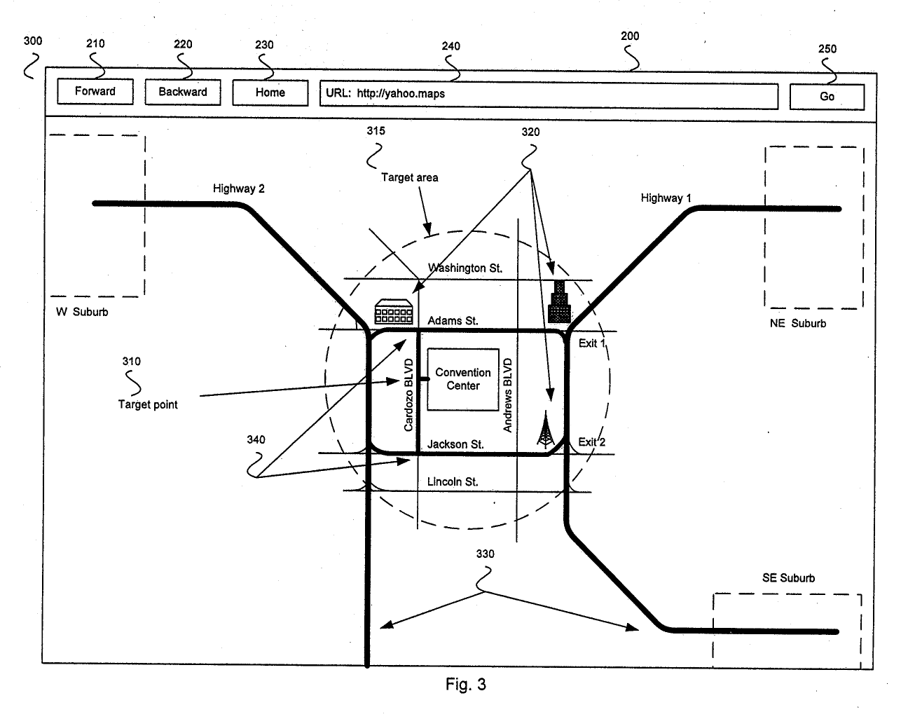

FIG. 3 is an exemplary webpage depicting a simplified point finding map

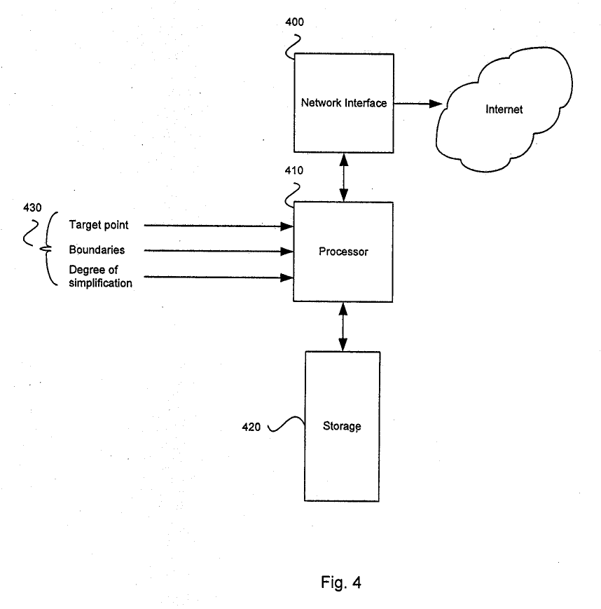

FIG. 4 is an exemplary system for generating simplified point finding maps

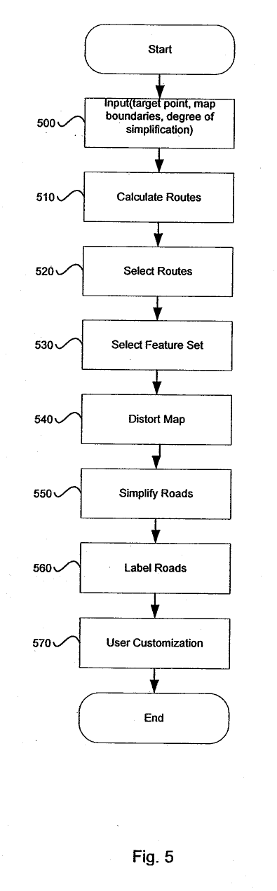

FIG. 5 is a block diagram of an exemplary flow chart for rendering simplified point finding maps

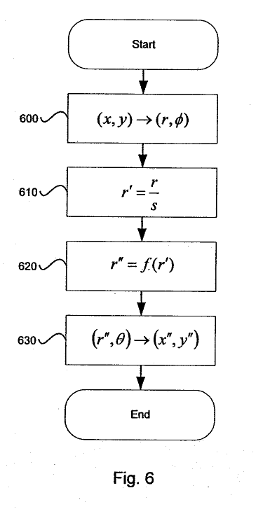

FIG. 6 is a block diagram of an exemplary flow chart for distorting a map.

### DETAILED DESCRIPTION OF THE INVENTION

A method and system is described for rendering simplified point finding maps. A method may include defining a boundary area and a target point within a target area, of a map that comprises multiple roads segments. A plurality of routes that go from the boundary area to the target point may be selected. Road segments that are not necessary to the routes may be removed from the map while road segments that intersect the routes may be included. Additionally, landmarks along the routes may be included based on a visibility parameter. The area of the map corresponding to the target area may be expanded to show more information by converting the map into a polar coordinate system and scaling the map utilizing a square root function or other suitable function.

The routes may be computed by treating the roads segments of the map as a weighted graph and the target point as a destination vertex and computing the plurality of routes utilizing, for example, an algorithm that searches backward from the destination vertex. The road segments may be rated by the number of routes on which they appear. Alternatively, the routes may be determined by selecting random locations outside the target area and generating multiple routes from the random locations to the target point.

FIG. 1 is a diagram of a user terminal connected to a web server via the internet. In FIG. 1, user terminal 100 connects to the internet and a web server 110 also connects to the internet. The web server 110 may include suitable logic, circuitry, and/or code that may enable generating web pages that may be viewed via computers connected to the internet. The web server 110 may be capable of rendering maps based on information provided by a user at the user terminal 100. For example, a user may navigate to a webpage for generating maps that resides on the web server 110. The user may then pan and zoom into an area of the map, such as a city, until he finds a desired portion of the map.

FIG. 2 is an exemplary webpage depicting an area on a map to be rendered as a simplified point finding map. In FIG. 2, a web browser 200, a forward button 210, a backward button 220, a home button 230, a address bar 240, a go button 250, a boundary area parameter 260, a target point parameter 270, a degree of simplification parameter 280, and a render button 290 are displayed. The web browser 200 may be run on a user terminal 100 and may be utilized to access web pages generated by a web server 110. The forward 210, backward 220, home 230, address bar 240 and go button 250 may be utilized to navigate to web sites. For example, a user may enter the URL of a web page for rendering simplified point finding maps into the address bar 240 and press the go button 250 to navigate to the web site. To go to the previous website the user may press the backward button 220. To return, the user may press the forward button 210. Finally, the home button 230 may be preprogrammed to cause the web browser to go to a home page.

The boundary area parameter 260 may correspond to the outer edge of a later rendered simplified point finding map. The target point parameter 270 may correspond to a point on a simplified point finding map where all routes may lead. The degree of simplification parameter 280 may be utilized, for example, to specify the number of routes to display on a later rendered simplified point finding map.

Utilizing a user terminal 100 (FIG. 1), a user may first navigate to a website for creating simplified point finding maps. The user may then pan and zoom in or out of a large map until he reaches the desired portion of the map. Next, the boundary area parameter 260, target point parameter 270, and degree of simplification parameter 280 may be specified. Finally, the user may click the render button 290 to produce a simplified point finding map.

FIG. 3 is an exemplary webpage depicting a simplified point finding map. In FIG. 3, a simplified point finding map 300, a target point 310, a target area 315, several landmarks near important intersections 320, several highway portions of routes 330, and several local road portions of routes 340 are displayed. The simplified point finding map 300 may be generated by the web server 110 (FIG. 1) and may correspond to a portion of a larger map. The portion may be defined by one or more parameters specified by a user via a user terminal 100 (FIG. 1). For example, parameters such as the target point parameter 270 (FIG. 2), the boundary area parameter 260 (FIG. 2), and the degree of simplification parameter 280 (FIG. 2) may be entered by the user at the user terminal 100. The boundary area parameter 260 may be utilized to specify a region of interest, such as a city and its suburbs. The web server 110 may then process the parameters and render a map, such as map 300, that shows the area within the boundary area parameter 260 of the original map and may center the map on the target point parameter 270.

Within the target area 315 of the simplified point finding map 300 more detail may be shown. For example, highway portions of routes 330 may be shown as well as local road portions of routes 340. The portion of the map 300 within the target area 315 may be expanded so that it may be easy to identify various local road portions of routes 340 within the target area 315. The portion of the map 300 outside of the target area 315 may be compressed so that longer routes may be represented. Additionally, less significant roads may be omitted outside of the target area 315. For example, only highway portions of routes 330 may be shown and the scale of the map 300 may be decreased so that large distances may be represented more easily. The simplified point finding map 300 may be distorted via a geometric form of distortion. For example, a polar coordinate system may be utilized to represent the simplified point finding map 300. The circumference of the target area 315 may be normalized to a radius of one. Then, a square root or other suitable function may be applied to the entire map. This process may have the effect of expanding the simplified point finding map 300 within the target area 315 and compressing it outside of the target area 315. Representing the simplified point finding map 300 in this manner may lead to a more efficient use of screen space and may make the map 300 easier to follow.

The simplified point finding map 300 may utilize the several landmarks near important intersections 320 to aid user navigation. For example, a picture of a famous landmark near an important intersection may be shown. This may make it easier for a user of the simplified point finding map 300 to find the important intersections. The determination of whether a landmark may be displayed may be based on heuristics or other metrics, such as the size of the landmark, or by estimating the importance of a landmark to a route. For example, a landmark just before an important intersection of a route may be more important than a landmark along a straight portion of the route.

It should be noted that simplified point finding map 300 shown in FIG. 3 is meant by way of example only. The map may be rendered differently. For example, the distortion may gradually change from expanded within the target area 315, to undistorted around the target area 315 perimeter to compressed outside the target area 315. The degree of detail shown may also change gradually going from the target point 310 toward the edge of the map.

FIG. 4 is an exemplary system for generating simplified point finding maps. In FIG. 4, a processor 410 connects with system storage 420, input parameters 430, and a network interface 400. The processor 410 may include suitable logic, circuitry, and/or code that may enable generating a simplified point finding map 300. Input parameters 430 may be communicated to the processor 410 that may control how the processor may generate the simplified point finding map 300 (FIG. 3). For example, the input parameters 430 may include a target point parameter 270 (FIG. 2), a boundary parameter 260 (FIG. 2), and a desired degree of simplification parameter 280 (FIG. 2). The target point parameter 270 may, for example, correspond to an address or the latitude and longitude of a target point 310 (FIG. 3) on the simplified point finding map 300. The boundary parameter 260 may be a bounding box, which may correspond to a portion of a larger map to show in the simplified point finding map 300. Alternatively, a map zoom level or travel distance from the target point 310 may be utilized to specify the portion of the larger map to show in the simplified point finding map 300.

The desired degree of simplification parameter 280 may, for example, be utilized to determine the number of roads to show or to determine whether landmarks should be depicted. For example, a first level of simplification may result in numerous routes to the target point 310 and landmarks being shown on the simplified point finding map 300. A second level of simplification may result in only a few key routes to the target point 310.

The processor 410 may further include suitable logic, circuitry, and/or code that may enable expanding and compressing portions of the map. The processor 410 may convert points in the map from Cartesian coordinates to polar coordinates and may then apply various functions to the converted map points. For example, the map points may be linearly scaled or a square root function may be applied to the map points. Scaling and applying a square root function to the map points may be utilized to represent the map in a distorted manner.

The system storage 420 may include suitable logic, circuitry, and/or code that may enable storing map and landmark information. A detailed map of, for example, the United States showing all roads may be stored. Pictures representing landmarks may be stored in the system storage 420 as well. For example, an actual picture of a landmark or an iconic representation of the landmark may be stored. A visibility parameter may be stored for each landmark and may represent the degree of visibility of the landmark from a given route. For example, a large building may have a higher degree of visibility than a smaller building.

The network interface 400 may include suitable logic, circuitry, and/or code that may enable communication of information over a network connection. In this regard, the network interface may be utilized to communicate the simplified point finding map 300 (FIG. 3) over the internet.

FIG. 5 is a block diagram of an exemplary flow chart of a logic for rendering simplified point finding maps. In FIG. 5, at block 500 a target point parameter 270, boundary area parameter 260 and desired degree of simplification parameter 280 may be entered by a user. The target point parameter 270 may, for example, correspond to an address or the latitude and longitude of a point of interest. The boundary area parameter 260 may be a bounding box, which may represent a portion of a map to show in the simplified point finding map 300 (FIG. 3). Alternatively, a map zoom level or travel distance from the target point parameter 270 may be entered instead. The desired degree of simplification 280 may be utilized to determine the number of roads to show or to determine whether landmarks should be depicted. For example, a first level of simplification may result in numerous routes to the target point 310 (FIG. 3) and landmarks 320 (FIG. 3) being shown on the simplified point finding map 300. A second level of simplification may result in only a few key routes being shown to the target point 310.

At block 510, various routes to the target point 310 may be calculated. This may be accomplished by treating the network of roads as a weighted graph and the target point parameter 270 as a destination vertex, and computing shortest paths to the vertex using an algorithm that searches backwards from the vertex. For example, a Dijkstra algorithm may be utilized to search backwards from the vertex. Road segments may be rated by the number of shortest paths on which they appear. Alternatively, the road segments may be computed by picking random locations outside of the target area 315 and generating routes from the random locations to the target point, then including the road segments based on frequency of use in these routes. Road segments that intersect the routes may be included based on their importance as an aid in navigating the routes.

At block 520, a subset of the previously calculated routes may be selected. For examples, the selection may be based on the road segment ratings calculated above. The number of routes selected may be based on the desired degree of simplification parameter 280. At block 530, a determination may be made as to which landmarks 320 (FIG. 3) may be included on the map. This may be accomplished by first estimating the visibility of a landmark based on, for example, heuristics or other metrics, such as the size of a landmark. Then the importance of the landmark to a route may be estimated. For example, a landmark near a change in direction of a route may be more important than a landmark that exists in the middle of a road segment. Upon making these determinations a ranked list of landmarks may be determined and added to the simplified point finding map.

At block 540, the geometry of the map may be distorted so that more information appears near within the target area 315 and less information appears outside of the target area 315. The distortion may be accomplished by applying a function that uniformly distorts the map. For example, a square root function may be utilized to distort the map in such a way that the portion of the map within the target area 315 may appear expanded and the portion of the map outside of the target area 315 may appear compressed. Alternatively, the target area 315 may be a standard zoomed-in map that is not distorted, while the area outside the target area 315 may be distorted in a manner similar to that described above. Applying these kinds of distortion techniques may result in a more efficient use of screen space and may make the map easier to follow without requiring computation that is prohibitively expensive.

At block 550, the roads displayed on the map may be simplified. For example, points that do not change how the road looks on the map may be removed. Also, details that are uninteresting to a user may be removed. At block 560, the roads that ultimately end up on the map may be labeled. At block 570, the user may customize the simplified map by selecting, for example, landmarks, photos, and text and adding them to the map.

FIG. 6 is a block diagram of an exemplary flow chart of a process for distorting a map. In block 600 the coordinate system of a map may be converted from a Cartesian coordinate system to polar coordinates and may be represented by the following equation:

(x,y)→(r,θ)

where x and y are the Cartesian coordinates for each point and r and θ are the polar coordinates of the same points. For example, a location that is 10 miles North and 10 miles east of the origin of the map may be represented with a radius of approximately 14 miles and an angle of 45 degrees from the horizontal access.

At block 610, the radius parameter of each point on the map may be scaled according to the following equation:

$${r}^{′} = \frac{r}{s}$$

where r corresponds to the radial value of each point and s corresponds to the amount of scaling to be applied to each point. Parameter s may equal the radius of a circle whose center is the target point 310 and along whose circumference there will be no distortion. Parameter s may be set automatically to a value that corresponds to approximately half the radial distance from the target point 310 to the boundary of the final map.

At block 620, a function for compressing and expanding different areas of the map may be applied to all points of the map and may be represented by the following equation:

r″=f(r′)

where f(r′) may correspond to the square root function. This may result in areas of the map within the target area 315 becoming expanded and areas of the map outside the target area 315 becoming compressed. For example, if the scale parameter in block 610 is 5 miles, areas of the map less than 5 miles from the target area 315 may have an expanded or zoomed in appearance and areas of the map outside of the 5 mile radius may have a compressed or zoomed out appearance. The amount of expansion or compression may vary with distance from the scale value defined in block 610.

At block 630, the map coordinates may be converted from polar coordinates back to Cartesian coordinates as represented by the following equation:

(r″,θ)→(x″,y″)

where x″ and y″ may correspond to the Cartesian representation of the converted map. This technique may result in a distortion that is geometric in nature and may result in more efficient use of screen space and may make the map easier to follow.

Another embodiment may provide a method for performing the blocks as described herein for rendering simplified point finding maps. For example, a boundary area specified by a boundary parameter 260 (FIG. 2) and a target point 310 (FIG. 3), of a map that comprises multiple roads segments, may be defined. A plurality of highway portions of routes 330 (FIG. 3) and local road portions of routes 340 (FIG. 3) routes that go from the boundary area specified by the boundary parameter 260 to the target point 310 may be selected. Road segments that are not necessary to the routes may be removed from the map while road segments that intersect the routes may be included. Additionally, landmarks near important intersections 320 (FIG. 3) may be included based on a visibility parameter. The portion of the map within the target area 315 may be expanded to show more information by converting the map into a polar coordinate system and scaling the map utilizing a square root function or other suitable function.

The routes may be computed by treating the roads segments of the map as a weighted graph and the target point 310 as a destination vertex and computing the plurality of routes using an algorithm that searches backwards from the vertex. For example, a Dijkstra algorithm may be utilized to search backwards from the vertex. The road segments may be rated by the number of routes on which they appear. Alternatively, the routes may be determined by selecting random locations outside the target area 315 and generating multiple routes from the random locations to the target point 310.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which included all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

What is claimed is:

1. A method for rendering a point finding map, the method comprising:
defining a boundary area and a target point within a target area, on a map comprising a plurality of roads segments, wherein the target area is within the boundary area;
calculating a plurality of routes from the boundary area to the target point, wherein each of the plurality of routes follows at least one of the plurality of road segments of the map;
removing at least one road segment of the plurality of road segments that is not part of the plurality of routes between the boundary and the target point.

2. The method according to claim 1, comprising treating the plurality of roads segments of the map as a weighted graph and the area within the target point as a destination vertex and computing the plurality of routes utilizing a search algorithm.

3. The method according to claim 1, comprising selecting random locations outside the target area and generating the plurality of routes from the selected random locations to the target point.

4. The method according to claim 1, comprising selecting a subset of the plurality of routes based on a frequency with which the road segments appear in the plurality of routes.

5. The method according to 1, comprising including road segments that intersect the plurality of routes.

6. The method according to claim 1, comprising including landmarks along the plurality of routes based on a visibility parameter.

7. The method according to claim 1, comprising compressing the map outside of the target area and expanding the map within the target area.

8. The method according to claim 1, comprising converting the map into a polar coordinate system and scaling the converted map utilizing a square root function.

9. A machine-readable storage having stored thereon, a computer program having at least one code section for rendering a point finding map, the at least one code section being executable by a machine for causing the machine to perform blocks comprising:
defining a boundary area and a target point within a target area, on a map comprising a plurality of roads segments, wherein the target area is within the boundary area;
calculating a plurality of routes from the boundary area to the target point, wherein each of the plurality of routes follows at least one of the plurality of road segments of the map;
removing at least one road segment of the plurality of road segments that is not part of the plurality of routes between the boundary and the target point.

10. The machine-readable storage according to claim 9, wherein the at least one code section comprises code that enables treating the plurality of roads segments of the map as a weighted graph and the area within the target point as a destination vertex and computing the plurality of routes utilizing a search algorithm.

11. The machine-readable storage according to claim 9, wherein the at least one code section comprises code that enables selecting random locations outside the target area and generating the plurality of routes from the selected random locations to the target point.

12. The machine-readable storage according to claim 9, wherein the at least one code section comprises code that enables selecting a subset of the plurality of routes based on a frequency with which the road segments appear in the plurality of routes.

13. The machine-readable storage according to claim 9, wherein the at least one code section comprises code that enables including road segments that intersect the plurality of routes.

14. The machine-readable storage according to claim 9, wherein the at least one code section comprises code that enables including landmarks along the plurality of routes based on a visibility parameter.

15. The machine-readable storage according to claim 9, wherein the at least one code section comprises code that enables compressing the map outside of the target area and expanding the map within the target area.

16. The machine-readable storage according to claim 9, wherein the at least one code section comprises code that enables converting the map into a polar coordinate system and scaling the converted map utilizing a square root function.

17. A system for rendering a point finding map, the system comprising:
one or more circuits that enables defining a boundary area and a target point within a target area, on a map comprising a plurality of roads segments, wherein the target area is within the boundary area;
the one or more circuits enables calculating a plurality of routes from the boundary area to the target point, wherein each of the plurality of routes follows at least one of the plurality of road segments of the map;
removing at least one road segment of the plurality of road segments that is not part of the plurality of routes between the boundary and the target point.

18. The system according to claim 17, wherein the one or more circuits enables treating the plurality of roads segments of the map as a weighted graph and the area within the target point as a destination vertex and computing the plurality of routes utilizing a search algorithm.

19. The system according to claim 17, wherein the one or more circuits enables selecting random locations outside the target area and generating the plurality of routes from the selected random locations to the target point.

20. The system according to claim 17, wherein the at least one code section comprises code that enables selecting a subset of the plurality of routes based on a frequency with which the road segments appear in the plurality of routes.

21. The system according to claim 17, wherein the one or more circuits enables including road segments that intersect the plurality of routes.

22. The system according to claim 17, wherein the one or more circuits enables including landmarks along the plurality of routes based on a visibility parameter.

23. The system according to claim 17, wherein the one or more circuits enables compressing the map outside of the target area and expanding the map within the target area.

24. The system according to claim 17, wherein the one or more circuits enables converting the map into a polar coordinate system and scaling the converted map utilizing a square root function.
